(19) United States
(12) Patent Application Publication
(10) Pub. No.: US 2024/0139976 A1
(43) Pub. Date: May 2, 2024

(54) FOLDING KNIFE WITH INTEGRATED SPACE SAVING COMPRESSION LOCK AND ACTUATOR

(71) Applicant: Black & Decker Inc., New Britain, CT (US)

(72) Inventors: Stephen Rowlay, Derbyshire (GB); Ralf Strauss, Stanley, NC (US)

(21) Appl. No.: 18/051,972

(22) Filed: Nov. 2, 2022

(51) Int. Cl. B26B 1/04; B26B 5/00

(52) U.S. Cl. CPC B26B 1/044; B26B 5/006

(57) ABSTRACT

A folding knife includes a handle, a blade assembly, a stop member, and a locking arm. The blade assembly is rotatably interconnected with the handle and is moveable between an extended position and a closed position. In the extended position, the locking arm exerts a bias force to wedge a releasable wedge member laterally between the stop member and the blade assembly to inhibit a transition of the folding knife out of the extended position. In the extended position, an unlocking force applied to the locking arm displaces the releasable wedge member from a space between the blade assembly and the stop member to permit the transition of the folding knife out of the extended position.

### FIELD

The present disclosure generally relates to folding knives and, more particularly, to folding knives with compression locks.

### BACKGROUND

Cutting instruments have been used for centuries by craftsmen, hunters, and others requiring a sharp cutting instrument. Folding knives are commonly carried by sportsmen, craftsmen and other users who desire a compact, portable blade that can be safely folded and transported in a pocket or attached to a belt. Folding knives generally have two stable positions. In an open or extended position, a cutting blade is extended to expose a cutting edge and permit cutting and use. In a closed position, the cutting edge of the blade is stored within a cavity or channel in the handle of the knife, thus inhibiting the blade from being exposed.

### SUMMARY

The following disclosure describes non-limiting examples of some embodiments. For instance, other embodiments of the disclosed systems and methods may or may not include the features described herein. Moreover, disclosed advantages and benefits can apply only to certain cases of the invention and should not be used to limit the disclosure. The embodiments disclosed herein each have several aspects, no single one of which is solely responsible for the disclosure's desirable attributes.

Embodiments of the present disclosure relate to folding knives. In some embodiments, a folding knife can include a handle, a blade assembly, a stop member, and a locking arm. The handle can include a housing. The blade assembly is rotatably interconnected with the handle and is moveable between an extended position of use and a closed position. The blade assembly can include a blade portion and a blade tang. The blade tang can define a cutout having an edge with an inclined surface. The stop member is interconnected with the handle. The locking arm is interconnected with and extends at least partially along a length of the handle. The locking arm can include a spring arm, a releasable wedge member, and an unlocking member. The unlocking member can include an overhang portion that extends from a first side of the housing to a second side of the housing. The unlocking member can include a user actuator portion coupled to the overhang portion. The user actuator portion can be configured to receive an unlocking force from a user from an exterior of the handle. In the extended position, the spring arm exerts a bias force to wedge the releasable wedge member laterally between the stop member and the inclined surface of the blade tang to inhibit a transition of the folding knife out of the extended position. In the extended position, the unlocking force applied to the user actuator portion displaces the releasable wedge member from a space between the inclined surface and the stop member to permit the transition of the folding knife out of the extended position.

The folding knife of any of the preceding paragraphs can include one or more of the following features. In the closed position, the blade assembly can be received in a space defined by the overhang portion and the spring arm. The overhang portion can extend away from a surface of the spring arm. The surface of the spring arm and the overhang portion can form a boundary for a receiving space. In the closed position, the blade assembly can be at least partially recessed in the receiving space. A length of the receiving space can be between about 6.5 mm and about 11 mm. A length of the receiving space can be about 8.2 mm. A width of the receiving space can be between about 7 mm. The overhang portion can form an arch or bridge shape to form a receiving space for a portion of the blade holder when the folding knife can be in the closed position.

The folding knife of any of the preceding paragraphs can include one or more of the following features. The unlocking force can be applied to the user interface via direct contact between the user and the user actuator portion. The folding knife can include a push button coupled to the user actuator portion. The unlocking force can be applied to the user interface via contact between the user and the push button. The unlocking force can include a force in a direction substantially perpendicular to a longitudinal axis of the handle. The unlocking force can include a pushing force in a direction toward the housing. The unlocking force can include a pulling force in a direction away from the housing. The overhang portion extends across an exterior surface of the housing. The locking arm can be a unitary member. The locking arm can be integrally formed with the housing. The wedge member can be positioned at a first end of the locking arm.

The folding knife of any of the preceding paragraphs can include one or more of the following features. The folding knife can include a belt clip integrally formed with the locking arm. A structure that includes the locking arm and the belt clip can be substantially u-shaped. The blade assembly can include a curved profile extending from the cutout to a notched region. The stop member can rest in the notched region when the folding knife is in the closed position. The stop member can be positioned proximate to an upper edge of the handle. The upper edge can be opposite a cutting edge of the folding knife. In the extended position, when pressure is applied downward on said upper edge of the blade assembly, the releasable wedge member can be compressed between the cutout and the stop member to prevent closure of said knife blade.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIGS. 1A-1D illustrate an example folding knife in accordance with the present disclosure.

FIG. 2 illustrates a side view of an example blade assembly of a folding knife.

FIGS. 3A-3C illustrate an example locking arm of a folding knife.

FIGS. 4A-4C illustrate various portions an example folding knife in an extended position.

FIGS. 5A and 5B illustrate various portions the folding knife in a closed position.

FIGS. 6A and 6B illustrate an example folding knife in accordance with the present disclosure.

FIG. 7 illustrates an example folding knife.

### DETAILED DESCRIPTION

Although certain embodiments and examples are described below, it will be understood that the disclosure extends beyond the specifically disclosed embodiments and/or uses and obvious modifications and equivalents thereof. Thus, it is intended that the scope of the disclosure herein disclosed should not be limited by any particular embodiments described below.

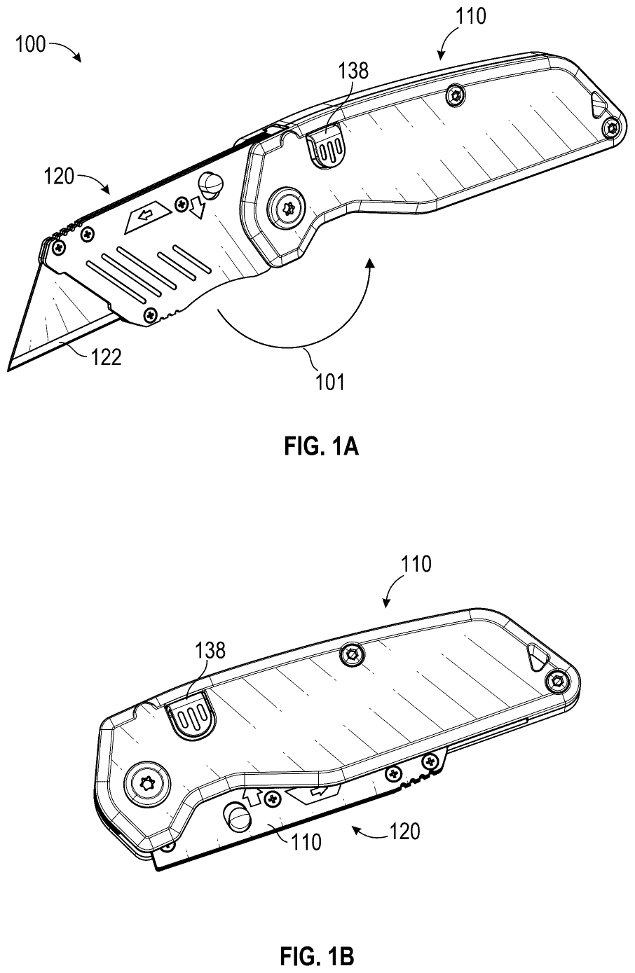

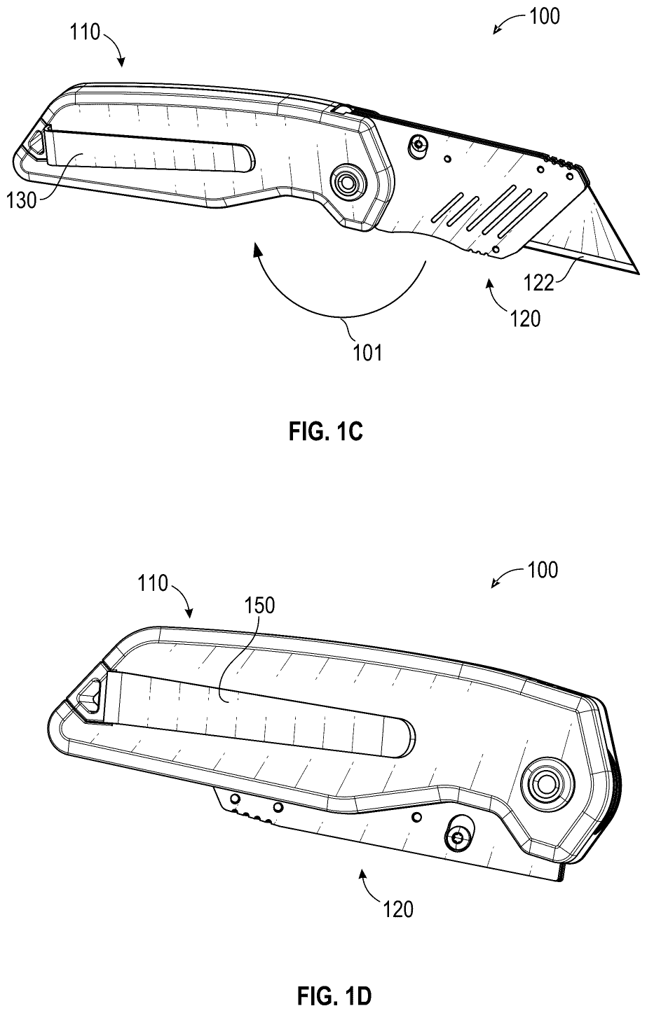

FIGS. 1A-1D illustrate an example folding knife 100 in accordance with the present disclosure. FIGS. 1A and 1B illustrate perspective views of a first side of the folding knife 100 in extended and closed positions, respectively, and FIGS. 1C and 1D illustrate perspective views of an opposite side of the folding knife 100 in the extended and closed positions, respectively. The folding knife 100 includes a handle 110, a blade assembly 120, a user actuator portion 138, and a belt clip 150.

In the extended position, a compression lock (not fully shown) maintains the folding knife 100 in the extended position. In the extended position, the cutting edge 122 of the blade assembly 120 is exposed. Upon application of an unlocking force to the user actuator portion 138 (e.g., via a user pressing the user actuator portion 138), the compression lock is released, thereby permitting rotational movement of the blade assembly 120 relative to the handle 110. While the compression lock is released, and when a downward force is applied to the blade assembly 120, the folding knife 100 can transition about the path 101 into the closed position. Such force may be gravity if the blade assembly 120 is loosely connected to the handle 110, or pressure if friction exists between the blade assembly 120 and the handle 110. In the closed position, the cutting edge 122 of the blade assembly 120 is no longer exposed. In some cases, in the closed position, the cutting edge 122 is positioned substantially within a cavity (not shown) defined by the handle 110. It will be understood that the folding knife 100 represents an example folding knife and other embodiments may include different features or configurations.

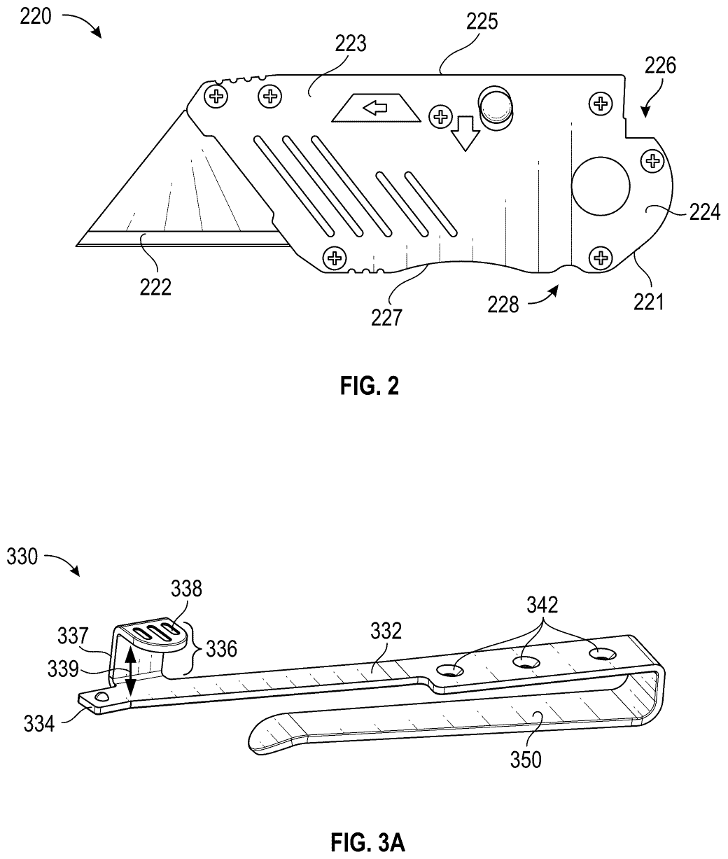

FIG. 2 illustrates a side view of an example blade assembly 220, which may be an embodiment of the blade assembly 120 of FIGS. 1A-1D. The blade assembly 220 includes a blade retainer 223 for receiving and retaining a blade 222, such as a standard utility blade (e.g., a trapezoidal utility blade). The blade retainer 223 includes a back portion (sometime referred to as a blade tang 224). The blade tang 224 includes a cutout region 226 for interacting with a wedge (e.g., the releasable wedge member 334) to lock the folding knife 100 in the extended position. As described further herein, an edge of the cutout region 226 can have an inclined surface (e.g., inclined surface 427). The inclined surface can be part of a contact surface that contacts the releasable wedge member to compress the releasable wedge member between the inclined surface and a stop member (e.g., stop member 470), and thereby form a part of the compression lock. In the illustrated example of FIG. 2, the cutout region 226 has a substantially rectangular shape. However, it will be understood that shape of the cutout region 226 can vary across embodiments.

The blade assembly 220 includes a curved profile 221 extending from the cutout region 226 to a notched region 228. When implemented in a folding knife, a stop member (e.g., stop member 470) of the folding knife can ride along the curved profile 221 during a transition between the closed and extended positions, and the stop member can rest in the notched region 228 when the folding knife 100 is in the closed position.

The blade assembly 220 includes an upper edge 225 and a lower edge 227. The upper edge 225 of the blade assembly can extend from the blade 222 to the cutout region 226. In some cases, the upper edge 225 has a substantially linear or flat profile, without substantial cutouts or indentations along the edge. In this way, the upper edge 225 can provide a relatively flat surface for interacting with an overhang portion of an unlocking member (e.g., the overhang portion 337 of the unlocking member 336). The lower edge 227 of the blade assembly can extend from the blade 222 to the curved profile 221. In some cases, the lower edge 227 includes at least a portion of the curved profile 221. In an embodiment, the lower edge 227 may extend below an axis or plane defined by a cutting edge of the blade 222.

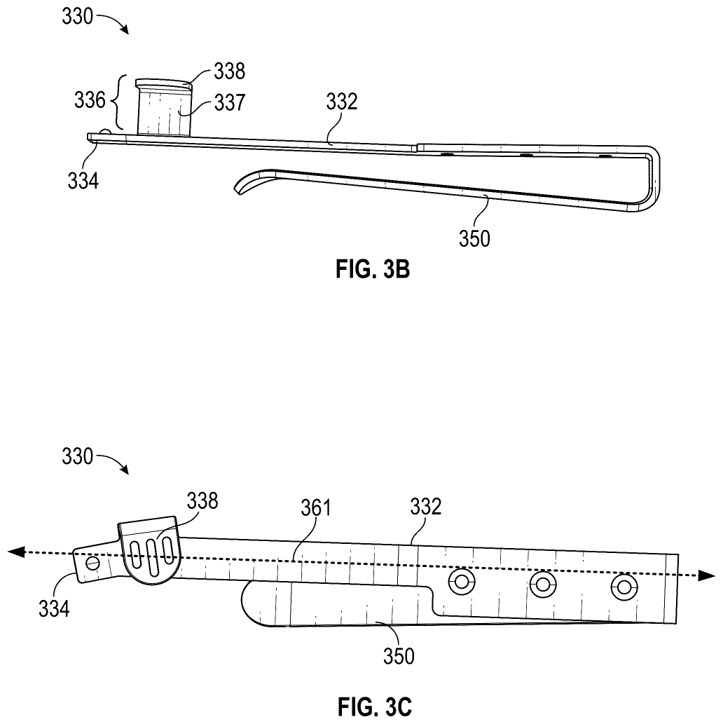

FIGS. 3A-3C illustrate an example locking arm 330. The locking arm 330 includes a spring arm 332, a releasable wedge member 334, an unlocking member 336, a housing securement interface 342, and a belt clip 350. It will be understood that FIGS. 3A-3C merely illustrate an example locking arm, and other embodiments may include fewer, more, or different components. For example, in some cases, the locking arm 330 may not include a belt clip 350.

The locking arm 330 can form part of a compression lock for use in a folding knife, such as the folding knife 100. For example, the locking arm 330 can be positioned within a folding knife such that the releasable wedge member 334 can be releasably wedged between a stop member (e.g., stop member 470) and a blade tang (e.g., the blade tang 224) to controllably inhibit closure of a folding knife (e.g., folding knife 100). In some cases, the spring arm 332 exerts a bias force to wedge the releasable wedge member 334 laterally between the stop member and the blade tang to inhibit a transition of the folding knife out of the extended position.

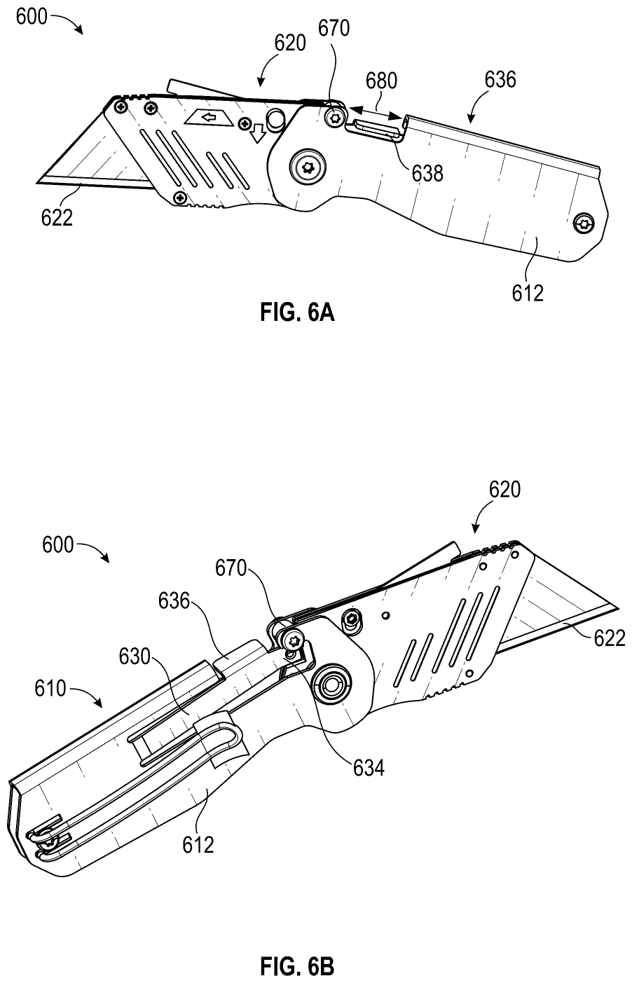

The unlocking member 336 includes an overhang portion 337 and a user actuator portion 338. The overhang portion 337 extends away from a surface of the spring arm 338, and the user actuator portion 338 may extend away from an edge of the overhang portion 337. In this way, the surface of the spring arm 332 and the unlocking member 336 form a boundary for a receiving space 339. The receiving space 339 advantageously provides clearance for rotational motion of the blade assembly 120, such that the blade assembly can at least partially recess in the receiving space 339 when the folding knife is in a closed position. It will be appreciated that the curvature and/or angle of the unlocking member 336 (and thus the size, volume, shape, etc. of the receiving space 339) can vary across embodiments. For example, in some cases, the unlocking member 336 forms an arch or bridge shape. As another example, in some cases (e.g., as illustrated in FIGS. 6A and 6B, the unlocking member 336 may not include a separately formed user actuator portion 338. In some such cases, the receiving space 339 is formed by the spring arm 332 and the overhang portion 337, and the user actuator portion 338 may constitute a terminal edge of the overhang portion 337.

The length of the receiving space 339 (e.g., the distance between the spring arm 332 and the user actuator portion 338) can vary across embodiments. For example, the length of the receiving space 339 can be in a range between about 3 mm and about 15 mm, between about 6.5 mm and about 11 mm, between about 7 mm and about 9 mm, or between about 7.5 mm and about 8.5 mm. As another example, the length of the receiving space 339 can be greater than 5 mm, greater than 7 mm, greater than 9 mm, greater than 11 mm, less than 13 mm, less than 12 mm, less than 10 mm, less than 9 mm, or less than 7.5 mm. As another example, the length of the receiving space 339 can be about 6.5, 7, 7.5, 8, 8.2, 8.5, 9, 9.5, or 10 mm (+/−about 1 mm). The width of the receiving space 339 (e.g., a width of the spring arm 332 under the overhang portion 337 and/or or a dimension perpendicular to the length of the receiving space 339) can vary across embodiments. For example, the width of the receiving space 339 can be in a range between about 3 mm and about 15 mm, between about 5 mm and about 10 mm, between about 6 mm and about 8 mm, or between about 6.5 mm and about 7.5 mm. As another example, the width of the receiving space 339 can be greater than 5 mm, greater than 7 mm, greater than 9 mm, greater than 11 mm, less than 13 mm, less than 12 mm, less than 10 mm, less than 9 mm, or less than 7.5 mm. As another example, the width of the receiving space 339 can be about 5.5, 6, 6.5, 7, 7.5, 8, 8.2, 8.5, 9, 9.5, or 10 mm (+/−about 1 mm).

The user actuator portion 338 is configured to receive an unlocking force from a user. For example, the user actuator portion 338 can function as a button that, when pressed, introduces an unlocking force onto the spring arm 332, thereby causing the releasable wedge member 334 to disengage from the space between the stop member and the blade tang and allowing the folding knife to be transitioned to a closed position.

The size, shape, and/or position of the releasable wedge member 334 can vary across embodiments. For example, in some cases, the releasable wedge member 334 is positioned at an end of, and is coplanar with, the spring arm 332. Alternatively, the releasable wedge member 334 may be positioned between ends of the spring arm 332 and/or may not be coplanar with the spring arm 332. For example, the releasable wedge member 334 may extend at an angle relative to a longitudinal axis 361 of the spring arm 332.

One or more portions of the locking arm 330 may be composed of a material having memory or resilience. For example, the locking arm 330 may be formed of metal, such as a single piece of spring steel. In some cases, the locking arm 300 is a unitary member, such that each of the spring arm 332, the releasable wedge member 334, the unlocking member 336, the housing securement interface 342, and the belt clip 350 are integrally formed. For example, in some cases, the belt clip 350 is integrated with the locking arm 330 such that it is a single unitary piece (e.g., monolithic). In some such cases, the locking arm 330 and belt clip 350 may form a U-shape and may be formed by a single piece of folded spring steel. In some such cases, when implemented in the folding knife 100, the belt clip 350 wraps around a back side of the housing 112 of the handle 110. A monolithically formed locking arm 330 plus belt clip 350 advantageously reduces the complexity of the compression lock and belt clip.

The housing securement interface 342 can facilitate coupling of the locking arm 330 to the handle of a folding knife. Although the housing securement interface 342 is illustrated as three apertures for receiving screws, it will be appreciated that the housing securement interface 342 can vary across embodiments. For example, in some cases, the housing securement interface 342 includes fewer or additional apertures. As another example, the housing securement interface 342 can include protrusions for mating with apertures of the handle. Furthermore, in some cases, the locking arm 330 may not include housing securement interface 342. For example, the locking arm 330 may be integrally formed with one or more portions of the handle, such as the handle housing.

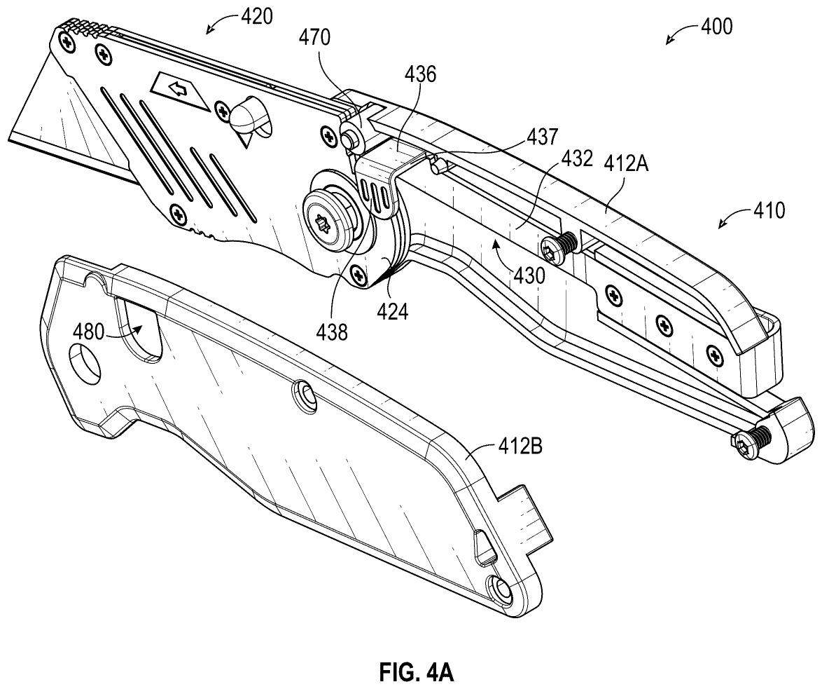

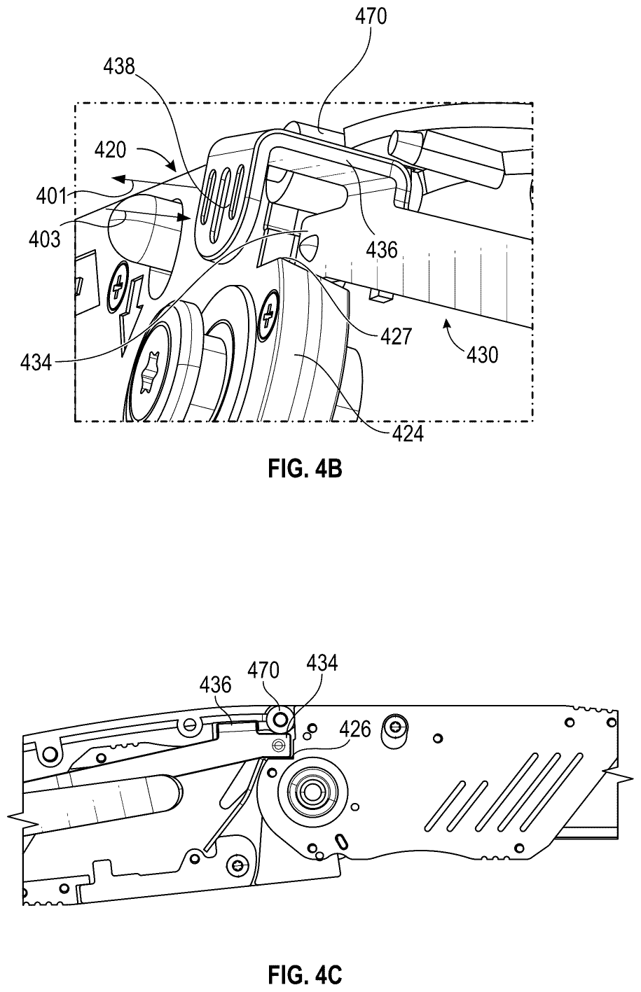

FIGS. 4A-4C illustrate various portions an example folding knife 400 in an extended position. In these examples, one or more portions 412A, 412B of the housing has been removed to increase visibility of components internal to the housing. The folding knife 400 is an embodiment of the folding knife 100 of FIGS. 1A-1D, and includes a locking arm, which is an embodiment of the locking arm 330 of FIGS. 3A-3C.

The folding knife 400 includes a handle 410 and a blade assembly 420 rotatably interconnected with the handle 410. In some embodiments, the blade assembly 420 may be constructed similarly to the blade assembly 220 as described above. The blade assembly 420 includes a blade tang 424 that defines a cutout having an edge with an inclined surface 427. The folding knife 400 further includes a stop member 470 interconnected with the handle 410, and a locking arm 430 interconnected with and extending at least partially along a length of the handle 410. The locking arm 430 includes a spring arm 432, a releasable wedge member 434, and an unlocking member 436.

The unlocking member 436 includes an overhang portion 437 that (when the housing portions 412A and 412B are connected) extends from a first side of the housing (e.g., on housing portion 412A to a second side of the housing (e.g., on housing portion 412B). The unlocking member 436 further includes a user actuator portion 438 coupled to the overhang portion 437. As described herein, the user actuator portion 438 is configured to receive an unlocking force from a user. The overhang portion 437 can have a flat or rectangular profile in some embodiments, such as that illustrated. In other embodiments, the overhang portion 437 may be curved or cylindrical. In various embodiments the overhang portion 437 may be integral to the spring arm 432, or may be coupled (e.g., attached, fastened, welded) thereto.

When the folding knife 400 is in an extended position, the spring arm 432 exerts a bias force in a first direction 401 to wedge the releasable wedge member 434 laterally between the stop member 470 and the inclined surface 427 of the blade tang 424. In some cases, the first direction 401 is substantially perpendicular to a longitudinal axis of the handle 410. By wedging the releasable wedge member 434 between the stop member 470 and the blade tang 424, the folding knife 400 advantageously inhibits wobble and inhibits a transition of the folding knife 400 out of the extended position.

To transition the folding knife 400 out of the extended position (also referred to as “unlocking” the folding knife 400), a user can apply an unlocking force on the user actuator portion 438 in a second direction 403. In some cases, the second direction 403 is substantially perpendicular to a longitudinal axis of the handle and/or substantially opposite the first direction 401. Application of the unlocking force on the user actuator portion 438 cause a cantilever motion of spring arm 432, thereby displacing the releasable wedge member 434 from a space between the inclined surface 427 and the stop member 470. In displacing the releasable wedge member 434 from the space between the inclined surface 427 and the stop member 470, the blade assembly 420 is free to rotate relative to the handle 410 towards the closed position.

As mentioned, the user actuator portion 438 is accessible to the user from an exterior of the handle 410. In some cases, the housing portion 412B includes an aperture 480 that accommodates the unlocking member 436 and/or the user actuator portion 438. For example, the aperture 480 can be sized to allow the user actuator portion 438 to fit therethrough, thereby allowing the unlocking member 436 and/or the user actuator portion 438 to extend from a first side of the housing (e.g., on housing portion 412A) to a second side of the housing (e.g. on housing portion 412B). In some cases, for example as illustrated in FIG. 4, the aperture 480 is enclosed such that the housing encircles the unlocking member 436 and/or the user actuator portion 438. In some cases, for example as illustrated in FIG. 8A, the aperture 480 is a cutout 426 and the housing such that the housing does not encircle the unlocking member 436 and/or the user actuator portion 438.

In some cases, the unlocking force is applied to the user actuator portion 438 via direct contact between the user and the user actuator portion 438. For example, the user actuator portion 438 may extend through the housing portion 412B and be accessible to the user. Alternatively, in some cases, the user actuator portion 438 may include one or more attachments thereto, such as a push button affixed to the user actuator portion 438. In some such cases, the unlocking force can be applied to the user actuator portion 438 via contact between the user and the push button.

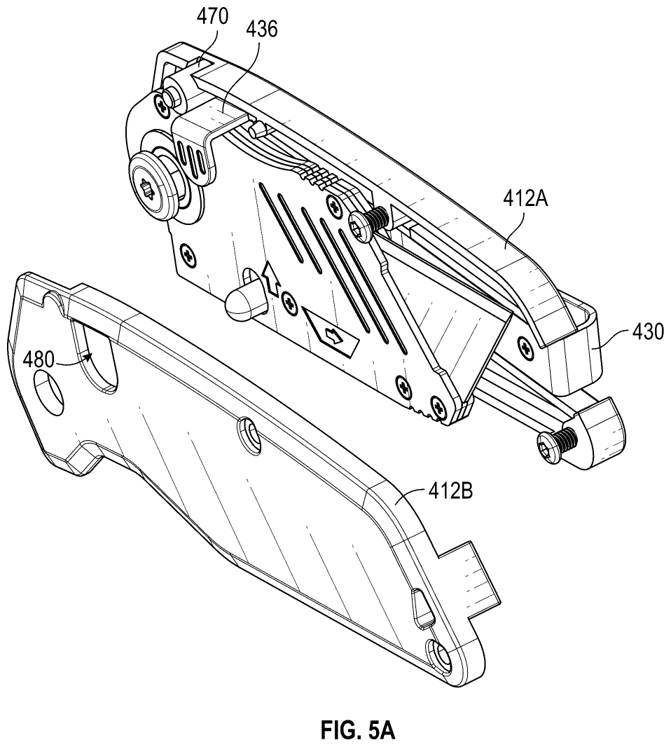

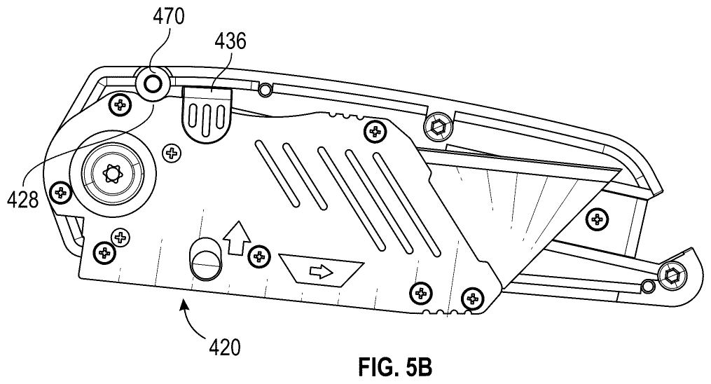

FIGS. 5A and 5B illustrate various portions the folding knife 400 in a closed position. In these examples, one or more portions 412A, 412B of the housing 410 has been removed to increase visibility of components internal to the housing. The folding knife 400 is an embodiment of the folding knife 100 of FIGS. 1A-1D, and includes a locking arm, which is an embodiment of the locking arm 330 of FIGS. 3A-3C.

When the folding knife 400 is in the closed position, the blade assembly 420 is positioned within the receiving space (e.g., receiving space 339) defined by the unlocking member 436 and the spring arm 432, the blade edge is no longer exposed, and the stop member 470 rests in the notched region 428. Furthermore, the spring arm 432 is biased in the second direction 403 by the structure of the blade assembly 420. In this way, the releasable wedge member 434 of the spring arm 432 will snap into the space between the inclined surface 427 and the stop member 470 when the folding knife 400 is opened.

In an embodiment where the blade assembly 420 is analogous to the blade assembly 220, it may be appreciated that when in the closed position, a lower surface of the overhang portion 437 contacts or is substantially adjacent to the structure of the blade assembly 420 analogous to the lower edge 227, thereby limiting protrusion of the blade assembly 420 out of the receiving space 339. In some cases, when in the closed position, the overhang portion 437 does not extend into an internal area of the blade assembly 420. For example, in some cases, the lower edge of the blade assembly 420 does not include a substantial divot or indentation into which the overhang portion 437 may extend; rather, the overhang portion 437 contacts an external region of the blade assembly 420. In this way, when in the closed position, the overhang portion 437 may not be enclosed or partially enclosed (e.g., covering some or all of three or more sides) by the blade assembly 420. Rather, in some cases, only one side of the overhang portion 437 contacts and/or is enclosed by the blade assembly 420.

FIGS. 6A and 6B illustrate an example folding knife 600, which is an embodiment of the folding knives 100 and 400 of FIGS. 1A-1D and FIGS. 4A-4C and. 5A-5B. The folding knife 600 includes a handle 610, a blade assembly 620, and a locking arm 630. Furthermore, in this example, the locking arm 630 is integrally formed with at least a portion of the housing 610 of the handle 610 such that it is a single unitary piece (e.g., monolithic). For instance, at least a portion of the housing 610 may be formed of sheet metal, and the locking arm 630 may be formed via a partial cutout of the sheet metal of the housing. By monolithically forming the locking arm 630 with the housing 610, the folding knife 600 advantageously provides space-savings and a reduction in complexity.

In this example, the unlocking member 636 does not include a defined user actuator portion. Rather, to unlock the folding knife 600, a user presses an end of the overhang portion 638. As such, in this example, the overhang portion 638 is configured to receive an unlocking force from a user from an exterior of the handle 610. In this example, the overhang portion 638 extends through a gap 680 in the housing 612.

The folding knife 600 can include a compression lock. For instance, in the illustrated example of FIG. 6, the stop member 670 is implemented as a bolt extending through the housing. In this way, in the extended position, the spring arm 630 can exert a bias force to wedge the releasable wedge member 634 laterally between the stop member 670 and a surface of the blade tang to inhibit a transition of the folding knife 600 out of the extended position.

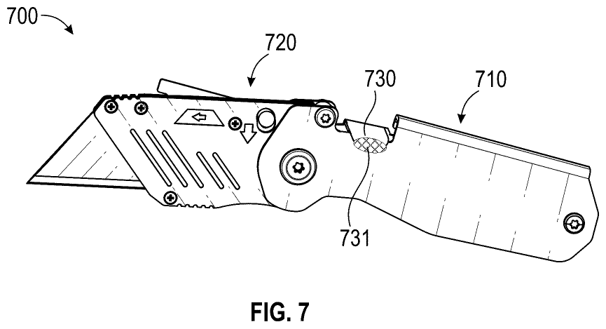

FIG. 7 illustrates an example folding knife 700, which is an embodiment of the folding knives 100 and 400 of FIGS. 1A-1D and FIGS. 4A-4C and. 5A-5B. The folding knife 700 includes a handle 710, a blade assembly 720, and a locking arm 730. Furthermore, in this example, the folding knife 700 includes a button member 731 (e.g., a push button) coupled to the locking arm 730 (e.g., to the user actuator portion). In this example, an unlocking force can be applied to the locking arm 730 via contact between the user and the button member 731. The button member 731 can be fixed to the locking arm 730 (e.g., to the user actuator portion), or can be carried by the handle 710 in some embodiments (e.g., sandwiched between the handle 710 and the locking arm 730. In some embodiments, the button member 731 may comprise a separate engageable member that provides a cushioned or ergonomic interface to a user pressing thereon, to transmit received unlocking forces from a user to the locking arm 730. Such button members 731 may comprise rubber, plastic, metal, or other appropriate constructions or configurations, and could comprise, for example, a resilient membrane or a generally rigid button insert received between the user actuator portion 438 and the aperture 480 of housing portion 412B.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “include,” “can include,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Depending on the embodiment, certain operations, acts, events, or functions of any of the routines described elsewhere herein can be performed in a different sequence, can be added, merged, or left out altogether (non-limiting example: not all are necessary for the practice of the algorithms). Moreover, in certain embodiments, operations, acts, functions, or events can be performed concurrently, rather than sequentially.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

Disjunctive language such as the phrase “at least one of X, Y, or Z,” unless specifically stated otherwise, is otherwise understood with the context as used in general to present that an item, term, etc., may be either X, Y, or Z, or any combination thereof (non-limiting examples: X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described elsewhere herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

What is claimed is:

1. A folding knife comprising:
a handle including a housing;
a blade assembly rotatably interconnected with the handle, the blade assembly comprising a blade portion and a blade tang, the blade tang defining a cutout having an edge with an inclined surface, the blade assembly moveable between an extended position of use and a closed position;
a stop member interconnected with the handle; and
a locking arm interconnected with and extending at least partially along a length of the handle, the locking arm comprising a spring arm, a releasable wedge member and an unlocking member, the unlocking member comprising an overhang portion that extends from a first side of the housing to a second side of the housing to a user actuator portion, the user actuator portion configured to receive an unlocking force from a user from an exterior of the handle,
wherein in the extended position the spring arm exerts a bias force to wedge the releasable wedge member laterally between the stop member and the inclined surface of the blade tang to inhibit a transition of the folding knife out of the extended position, and
wherein in the extended position the unlocking force applied to the user actuator portion displaces the releasable wedge member from a space between the inclined surface and the stop member to permit the transition of the folding knife out of the extended position.

2. The folding knife of claim 1, wherein in the closed position the blade assembly is received in a space defined by the overhang portion and the spring arm.

3. The folding knife of claim 1, wherein the overhang portion extends away from a surface of the spring arm, wherein the surface of the spring arm and the overhang portion form a boundary for a receiving space, wherein in the closed position the blade assembly is at least partially recessed in the receiving space.

4. The folding knife of claim 3, wherein a length of the receiving space is between about 6.5 mm and about 11 mm.

5. The folding knife of claim 4, wherein a length of the receiving space is about 8.2 mm.

6. The folding knife of claim 3, wherein a width of the receiving space is between about 5 mm and about 10 mm.

7. The folding knife of claim 1, wherein the overhang portion forms an arch or bridge shape to form a receiving space for a portion of the blade holder when the folding knife is in the closed position.

8. The folding knife of claim 1, wherein the unlocking force is applied to the user interface via direct contact between the user and the user actuator portion.

9. The folding knife of claim 1, further comprising a push button coupled to the user actuator portion, wherein the unlocking force is applied to the user interface via contact between the user and the push button.

10. The folding knife of claim 1, wherein the unlocking force comprises a force in a direction substantially perpendicular to a longitudinal axis of the handle.

11. The folding knife of claim 1, wherein the unlocking force comprises a pushing force in a direction toward the housing.

12. The folding knife of claim 1, wherein the unlocking force comprises a pulling force in a direction away from the housing.

13. The folding knife of claim 1, wherein the overhang portion extends across an exterior surface of the housing.

14. The folding knife of claim 1, wherein the locking arm is a unitary member.

15. The folding knife of claim 1, wherein the locking arm is integrally formed with the housing.

16. The folding knife of claim 1, wherein the wedge member is positioned at a first end of the locking arm.

17. The folding knife of claim 14, wherein further comprising a belt clip integrally formed with the locking arm, wherein a structure comprising the locking arm and the belt clip is substantially u-shaped.

18. The folding knife of claim 1, wherein the blade assembly comprises a curved profile extending from the cutout to a notched region, wherein the stop member rests in the notched region when the folding knife is in the closed position.

19. The folding knife of claim 1, wherein the stop member is positioned proximate to an upper edge of the handle, the upper edge being opposite a cutting edge of the folding knife.

20. The folding knife of claim 1, wherein in the extended position, when pressure is applied downward on said upper edge of the blade assembly, the releasable wedge member is compressed between the cutout and the stop member to prevent closure of said knife blade.
